(19) United States
(12) Patent Application Publication
(10) Pub. No.: US 2026/0159105 A1
(43) Pub. Date: Jun. 11, 2026

(54) PERCEPTION DATA GEOMETRY CALIBRATION SYSTEM

(71) Applicant: GM Global Technology Operations LLC, Detroit, MI (US)

(72) Inventors: Bo Yu, Troy, MI (US); Gui Chen, Sterling Heights, MI (US); Guanyang Luo, Warren, MI (US); Milan Kumar Biswal, Las Cruces, NM (US); Mason David Gemar, Cedar Park, TX (US)

(21) Appl. No.: 18/973,836

(22) Filed: Dec. 9, 2024

(51) Int. Cl. B60W 50/06

(52) U.S. Cl. CPC B60W 50/06; B60W 2556/40; B60W 2556/45

(57) ABSTRACT

A perception data geometry calibration system calibrates perception data geometry captured by one or more vehicles located within a predefined geographical area. In one embodiment, the perception data geometry system includes one or more central computers that receive local map data representing the predefined geographical area from a particular vehicle and corresponding high-definition map data over a communication network. The local map data includes a plurality of perception data geometry features that define objects within an environment surrounding the particular vehicle. The one or more central computers determine a unique calibrated scaling ratio for each road segment that is part of a vehicle trajectory based on one or more non-linear optimization algorithms by minimizing a cost function between road-segment points that represent a particular perception data geometry feature based on the local map data with corresponding road-segment points that are based on the high-definition map data.

### INTRODUCTION

The present disclosure relates to a perception data geometry calibration system that calibrates perception data geometry captured by one or more vehicles.

An autonomous vehicle executes various tasks such as, but not limited to, perception, localization, mapping, path planning, decision making, and motion control. Autonomous vehicles rely upon map data for many of the tasks that are executed such as localization, mapping, and path planning. One example of a version of map data is based on perception data collected by the perception sensors of a vehicle. An individual autonomous vehicle may include numerous perception sensors such as, for example, a front camera module, radar, and LIDAR. The front camera module may capture image data representing the environment surrounding a particular vehicle. The image data may be used to extract perception data geometry that represents the position of various objects within the environment such as, for example, lanes on a roadway, road signs, and traffic lights.

It is to be appreciated that inaccurate perception data geometry extracted from the image data that is captured by the front camera module may create issues with map generation. Specifically, for example, the lane lines extracted from the image data captured by the front camera module may be spaced narrower or wider than the actual real-life lane lines. Some possible causes of the inaccurate perception geometry data include, but are not limited to, inaccurate factory calibration of the front camera module, a change in camera height due to events such as changes in tire pressure or the suspension, and the fact that there is a crown in the roadway to direct water towards the road edges or the gutters. The inaccurate perception geometry data may cause the map data, which is determined based on the perception data, to indicate an incorrect position of the lane lines. The incorrect position of the lane lines may cause issues with localization and lead to incorrect decisions made by the autonomous vehicle's control system. Furthermore, in the event the perception data is crowdsourced with perception data captured by other vehicles within the vicinity, if even one lane line position is inaccurate then the aggregated lane line map error accumulates across multiple lane lanes that are part of a multi-lane freeway.

One approach to alleviate the above-mentioned issues with inaccurate perception geometry data involves using a scaling ratio to adjust the width between the lane lines captured by the front camera module. However, the scaling ratio may not be used over multiple vehicles of various make and models. In fact, even when there is only one vehicle involved, the value of the scaling ratio may change over time.

Thus, while maps for autonomous vehicles achieve their intended purpose, there is a need in the art for an improved approach for calibrating a scaling ratio to improve the accuracy of perception data.

### SUMMARY

According to several aspects, a perception data geometry calibration system that calibrates perception data geometry captured by one or more vehicles located within a predefined geographical area is disclosed. The perception data geometry calibration system includes one or more central computers in wireless communication with the one or more vehicles and one or more communication networks for receiving high-definition map data. The one or more central computers executes instructions to receive local map data representing the predefined geographical area from a particular vehicle and corresponding high-definition map data over the communication network, where the local map data includes a plurality of perception data geometry features that define objects within an environment surrounding the particular vehicle. The one or more central computers divide a vehicle trajectory that is determined based on perception data collected from the particular vehicle into a plurality of road segments. The one or more central computers determine a unique calibrated scaling ratio for each road segment that is part of the vehicle trajectory based on one or more non-linear optimization algorithms, where the one or more central computers iteratively calculate the unique calibrated scaling ratio to minimize a cost function between road-segment points that represent a particular perception data geometry feature based on the local map data with corresponding road-segment points that are based on the high-definition map data, and calibrate the plurality of perception data geometry features included by the local map data based on the unique calibrated scaling ratio corresponding to each road segment that is part of the vehicle trajectory to create a corrected local map.

In another aspect, the one or more central computers execute instructions to evaluate the unique calibrated scaling ratio corresponding to each road segment that is part of the vehicle trajectory to identify any outliers based on one or more outlier removal approaches.

In yet another aspect, the outlier removal approaches include one or more of the following: a random sample consensus (RANSAC) algorithm, a z-score, and a density-based spatial clustering of applications with noise (DBSCAN) algorithm.

In an aspect, the one or more central computers execute instructions to determine the unique calibrated scaling ratio by: finding an association between the road-segment points that represent a particular perception data geometry feature within the local map data with the corresponding road-segment points within the high-definition map data that also represent the particular perception data geometry feature for each road segment that is part of the vehicle trajectory.

In another aspect, the one or more central computers execute instructions to determine the unique calibrated scaling ratio by: calculating a cost function based on a Euclidean distance between each road-segment point within the local map data and the corresponding road-segment point that is based on the high-definition map data for each road segment that is part of the vehicle trajectory.

In yet another aspect, the cost function is determined based on:

$$cost\_function ( HD\_map , local\_map ) = \frac{{\sum }_{i} dist ( {p}_{i} , {q}_{i} ) \cdot weight ( {p}_{atti} , {q}_{atti} )}{n}$$

where pᵢ, qᵢ represent a pair of associated points and pᵢ is a point from the high-definition map data HDₘₐₚ and qᵢ is a point from the local map data localₘₐₚ, pₐₜₜᵢ, qₐₜₜᵢ represent attributes of the perception data geometry features associated with the pair of associated points pᵢ, qᵢ, n represents a total number of associated point pairs, and cost_function(HD_map, local_map) represents the cost function.

In an aspect, the perception data geometry features include one or more of the following: lane lines along a roadway, road signs, traffic lights, and location coordinates.

In another aspect, the perception data geometry features are lane lines and the attributes include one or more of the following: line color and line type.

In yet another aspect, a length of each road segment is equal to an average accurate perception range of the particular vehicle.

In an aspect, a perception data geometry calibration system that calibrates perception data geometry captured by one or more vehicles located within a predefined geographical area is disclosed. The perception data geometry calibration system includes a plurality of perception sensors that capture collect perception data regarding the predefined geographical area and one or more controllers in electronic communication with the plurality of perception sensors, wherein the one or more controllers are part of a particular vehicle that receives high-definition map data over a communication network. The one or more controllers execute instructions to determine local map data based on the perception data collected by the plurality of perception sensors, where the local map data includes a plurality of perception data geometry features that define objects within an environment surrounding the particular vehicle. The one or more controllers divide a vehicle trajectory that is determined based on perception data collected from the particular vehicle into a plurality of road segments and determine a unique calibrated scaling ratio for each road segment that is part of the vehicle trajectory based on one or more non-linear optimization algorithms, where the one or more controllers iteratively calculate the unique calibrated scaling ratio to minimize a cost function between road-segment points that represent a particular perception data geometry feature based on the local map data with corresponding road-segment points that are based on the high-definition map data. The one or more controllers calibrate the plurality of perception data geometry features included by the local map data based on the unique calibrated scaling ratio corresponding to each road segment that is part of the vehicle trajectory to create a corrected local map.

In another aspect, the one or more controllers execute instructions to evaluate the unique calibrated scaling ratio corresponding to each road segment that is part of the vehicle trajectory to identify any outliers based on one or more outlier removal approaches.

In yet another aspect, a perception data geometry calibration system that calibrates perception data geometry captured by two or more vehicles located within a predefined geographical area is disclosed. The perception data geometry calibration system includes one or more central computers in wireless communication with the two or more vehicles. The one or more central computers executes instructions to receive a first set of perception data representative of the predefined geographical area captured by a first vehicle and a second set of perception data representative of the predefined geographical area captured by a second vehicle. The one or more central computers create a first point cloud map representative of the predefined geographical area based on the first set of perception data and a second point cloud map representative of the predefined geographical area based on the second set of perception data, where the first point cloud map and the second point cloud map include a plurality of perception data geometry features that define objects within an environment surrounding the first vehicle and the second vehicle. The one or more central computers align the first point cloud map and the second point cloud map with respect to the world coordinate system based on a global navigation satellite system (GNSS) data collected a corresponding vehicle. The one or more central computers divide a vehicle trajectory that is determined based on perception data collected from the first vehicle and the second vehicle into a plurality of road segments. The one or more central computers determine a unique calibrated scaling ratio for each road segment that is part of the vehicle trajectory based on one or more non-linear optimization algorithms, where the one or more central computers iteratively calculate the unique calibrated scaling ratio to minimize a cost function between point cloud data points that represent a particular perception data geometry feature based on the first point cloud map with corresponding point cloud data points that are based on the second point cloud map and calibrate the plurality of perception data geometry features included by the first point cloud map based on the unique calibrated scaling ratio corresponding to each road segment that is part of the vehicle trajectory to create a corrected first point cloud map.

In another aspect, the one or more central computers execute instructions to evaluate the unique calibrated scaling ratio corresponding to each road segment that is part of the vehicle trajectory to identify any outliers based on one or more outlier removal approaches.

In yet another aspect, the outlier removal approaches include one or more of the following: a RANSAC algorithm, a z-score, and a DBSCAN algorithm.

In an aspect, the one or more central computers execute instructions to determine the unique calibrated scaling ratio by finding an association between the point cloud data points that represent a particular perception data geometry feature within the first point cloud map with the corresponding point cloud data points within the second point cloud map that also represent the particular perception data geometry feature for each road segment that is part of the vehicle trajectory.

In another aspect, the one or more central computers execute instructions to determine the unique calibrated scaling ratio by calculating a cost function based on a Euclidean distance between each point cloud data point within the first point cloud map and the corresponding point cloud data point that is based on the second point cloud map for each road segment that is part of the vehicle trajectory.

In yet another aspect, the cost function is determined based on:

$$cost\_function ( v1\_local \_map , v2\_local \_map ) = \frac{{\sum }_{i} dist ( {p}_{i} , {q}_{i} ) \cdot weight ( {p}_{atti} , {q}_{atti} )}{n}$$

where pᵢ, qᵢ represent a pair of associated points and pᵢ is a point from the second point cloud map v2_localₘₐₚ and qᵢ is a point from the first point cloud map v1_localₘₐₚ, and pₐₜₜᵢ, qₐₜₜᵢ represent attributes of the perception data geometry features associated with the pair of associated points pᵢ, qᵢ, n represents a total number of f associated point pairs, and cost_function(v1_local_map, v2_local_map) represents the cost function.

In another aspect, the perception data geometry features include one or more of the following: lane lines along a roadway, road signs, traffic lights, and location coordinates.

In yet another aspect, the perception data geometry features are lane lines and the attributes include one or more of the following: line color and line type.

In an aspect, a length of each road segment is equal to an average accurate perception range of either the first vehicle or the second vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of the disclosed perception data geometry calibration system that includes one or more central computers in wireless communication with a plurality of vehicles and a wireless network for receiving high-definition map data, according to an exemplary embodiment;

FIG. 2 is a block diagram illustrating one embodiment of the software architecture for the one or more central computers shown in FIG. 1, according to an exemplary embodiment;

FIG. 3 is a diagram of road-segment points that represent a particular perception data geometry feature within the environment with corresponding road-segment points that are based on the high-definition map data, according to an exemplary embodiment;

FIG. 4 is a block diagram illustrating yet another embodiment of the software architecture for the one or more central computers shown in FIG. 1, according to an exemplary embodiment; and

FIG. 5 is a diagram of road-segment points that represent a particular perception data geometry feature within the environment captured by a first vehicle with corresponding road-segment points that are captured by a second vehicle, according to an exemplary embodiment.

### DETAILED DESCRIPTION

The following description is merely exemplary in nature and is not intended to limit the present disclosure, application, or uses.

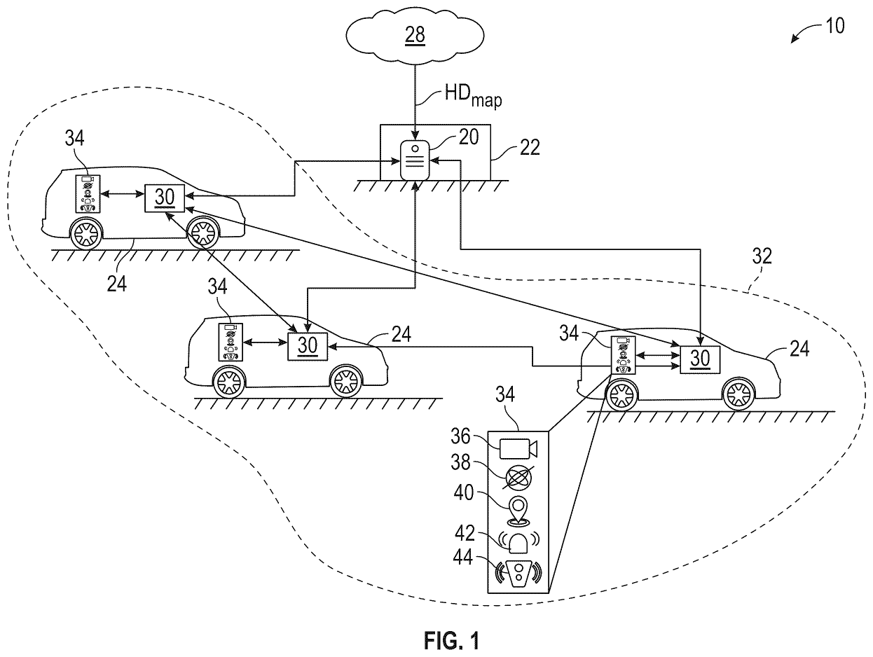

Referring to FIG. 1, an exemplary perception data geometry calibration system 10 is illustrated. The perception data geometry calibration system 10 includes one or more central computers 20 located at a back-end office 22 in wireless communication with one or more controllers 30 that each correspond to one of a plurality of vehicles 24. It is to be appreciated that the plurality of vehicles 24 may each be any type of vehicle such as, but not limited to, a sedan, a truck, sport utility vehicle, van, or motor home. As seen in FIG. 1, the plurality of vehicles 24 are located within a predefined geographical area 32. The predefined geographical area 32 may represent any geographical area such as, for example, a neighborhood, city, town, or state such as Michigan or Ohio. In one embodiment, the one or more central computers 20 may also obtain high-definition (HD) map data HDₘₐₚ representing the predefined geographical area 32 via the one or more communication networks 28.

In the non-limiting embodiment as shown in FIG. 1, each vehicle 24 includes a plurality of perception sensors 34 that collect perception data regarding the predefined geographical area 32, where the perception sensors 34 are in electronic communication with the one or more controllers 30. The one or more controllers 30 of each vehicle 24 are in wireless communication with the one or more central computers 20 as well as the one or more controllers 30 corresponding to one or more remaining vehicles 24. As seen in FIG. 1, the plurality of perception sensors 34 of each vehicle 24 include one or more cameras 36 that collect image data, an inertial measurement unit (IMU) 38, a global navigation satellite system (GNSS) 40, radar 42, and LiDAR 44, however, is to be appreciated that different or additional sensors may be used as well. The one or more cameras 36 collect image data representative of the predefined geographical area 32. In one non-limiting embodiment, the one or more cameras 36 may include a front camera module.

Each vehicle 24 determines local map data localₘₐₚ representative of the predefined geographical area 32 based on the perception data collected by the respective perception sensors 34. The one or more controllers 30 of each vehicle 24 may transmit a corresponding local map data localₘₐₚ representative of the predefined geographical area 32 over the communication network 28 to the one or more central computers 20.

It is to be appreciated that the local map data localₘₐₚ representative of the predefined geographical area 32 includes a plurality of perception data geometry features that define objects within an environment surrounding a particular vehicle 24, where the perception data geometry features are determined based on the image data captured by the one or more cameras 36. Some examples of the perception data geometry features include, but are not limited to, lane lines along a roadway, road signs, traffic lights, and location coordinates such as, for example, two-dimensional coordinates that indicate a latitude and longitude or three-dimensional coordinates such as x, y, z coordinates.

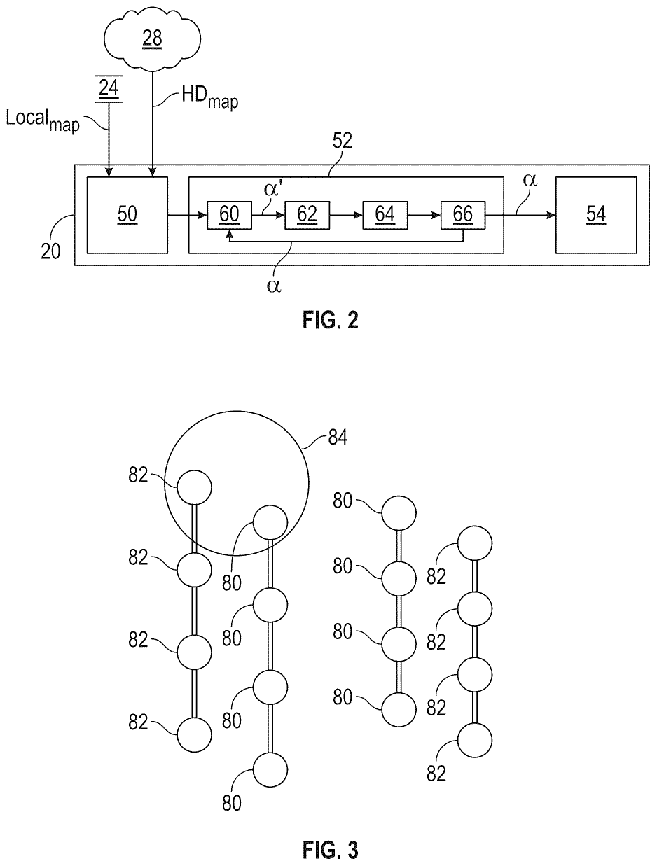

FIG. 2 is a block diagram illustrating one embodiment of software architecture for the one or more central computers 20 shown in FIG. 1. In the example as shown in FIG. 2, the one or more central computers 20 includes a segmentation module 50, a non-linear optimization module 52, and an outlier removal module 54. Referring to both FIGS. 1 and 2, the segmentation module 50 of the one or more central computers 20 receives the local map data localₘₐₚ representative of the predefined geographical area 32 from a particular vehicle 24 that is part of the plurality of vehicles 24 and the high-definition map data HDₘₐₚ over the communication network 28. In one embodiment, the one or more central computers 20 may receive the perception data collected by the respective perception sensors 34 from the particular vehicle 24, and then calculates the local map data localₘₐₚ representative of the predefined geographical area 32 based on the perception data collected by the particular vehicle 24 instead. In embodiment, the one or more central computers 20 receive the either the local map data localₘₐₚ or the perception data collected by the respective perception sensors 34 from more than one vehicle 24.

As explained below, the one or more central computers 20 calculates a calibrated scaling ratio α. In the embodiment as shown in FIG. 2, the calibrated scaling ratio α is based on a difference between corresponding perception data geometry features located within local map data localₘₐₚ and the high-definition map data HDₘₐₚ, where the high-definition map data HDₘₐₚ IS considered ground truth data. It is to be appreciated that the calibrated scaling ratio α is a function of time, a location of a particular vehicle 24, a lateral distance between a specific perception data geometry feature and the particular vehicle 24, the make and model of the particular vehicle 24, road curvature, a color of a lane line, the quality of a lane line, and estimated horizontal position error (EHPE). Once the calibrated scaling ratio α is determined, the one or more central computers 20 may then calibrate the plurality of perception data geometry features included by the local map data localₘₐₚ based on the calibrated scaling ratio α. The calibrated local map data localₘₐₚ may then be used for various applications. For example, the calibrated local map data localₘₐₚ may be transmitted back to the particular vehicle 24.

It is to be appreciated that while FIG. 2 illustrates the software architecture for the one or more central computers 20, a similar architecture may be included by the one or more controllers 30 of a vehicle 24 as well. In other words, it is to be appreciated that while FIG. 2 illustrates the one or more central computers 20 determining the calibrated scaling ratio α, in another embodiment the one or more controllers 30 of one of the vehicles 24 may determine the calibrated scaling ratio α instead. In this embodiment, the one or more controllers 30 of the vehicle receive the high-definition map data HDₘₐₚ over the communication network 28.

Referring to FIGS. 1 and 2, the segmentation module 50 of the one or more central computers 20 divides a vehicle trajectory that is determined based on the perception data collected from a particular vehicle 24 into a plurality of road segments. Each of the plurality of road segments includes the same length, where the length of each road segment may be equal to an average accurate perception range of the particular vehicle 24. In one non-limiting embodiment, the length is about one hundred meters.

The non-linear optimization module 52 of the one or more central computers 20 receives the plurality of road segments from the segmentation module 50 and the high-definition map data HDₘₐₚ representing the predefined geographical area 32 via the one or more communication networks 28. The non-linear optimization module 52 determines a unique calibrated scaling ratio a for each road segment that is part of the vehicle trajectory based on one or more non-linear optimization algorithms, where the non-linear optimization module 52 of the one or more central computers 20 iteratively calculates the unique calibrated scaling ratio α to minimize a cost function between the road-segment points 80 (shown in FIG. 3) that represent a particular perception data geometry feature within the predefined geographical area 32 that are based on the local map data localₘₐₚ with corresponding road-segment points 82 (FIG. 3) that are based on the high-definition map data HDₘₐₚ. One example of a non-linear optimization algorithm that may be used is the Levenberg-Marquardt algorithm. As seen in FIG. 2, the non-linear optimization module 52 of the one or more central computers 20 includes a scaling ratio submodule 60, an association submodule 62, a cost function submodule 64, and a non-linear optimization submodule 66.

Referring to FIGS. 2 and 3, the scaling ratio submodule 60 of the non-linear optimization module 52 first selects a temporary scaling ratio α′ that corresponds to a particular road segment that is part of the vehicle trajectory. In one non-limiting embodiment, the temporary scaling ratio α′ is a predetermined value that may range from 0.9 to 1.2, however, it is to be appreciated that other values for the temporary scaling ratio α′ may be used as well. The association submodule 62 of the non-linear optimization module 52 may then find an association between the road-segment points 80 (shown in FIG. 3) that represent a particular perception data geometry feature within the local map data localₘₐₚ with corresponding road-segment points 82 within the high-definition map data HDₘₐₚ that also represent the particular perception data geometry feature for the particular road segment.

Referring specifically to FIG. 3, a circle 84 is drawn around each road-segment point 80 and its corresponding road-segment point 82. It is to be appreciated that each road segment may include more than one road-segment point 80 and a corresponding road-segment point 82 that is based on the high-definition map data HDₘₐₚ. The association between the road-segment points 80 and the corresponding road-segment points 82 that are based on the high-definition map data HDₘₐₚ may be determined based on a variety of approaches such as, for example, the point cloud registration approach or the feature matching approach.

Once the association between the road-segment points 80 and the corresponding road-segment points 82 for the particular road segment has been determined, the cost function submodule 64 of the non-linear optimization module 52 may then calculate a cost function based on a Euclidean distance between each road-segment point 80 within the local map data localₘₐₚ and the corresponding road-segment point 82 that is based on the high-definition map data HDₘₐₚ for the particular road segment. The unique calibrated scaling ratio α corresponding to the particular road segment is selected to minimize the cost function. Specifically, in one embodiment, the cost function is determined based on Equation 1, which is:

$$cost\_function ( HD\_map , local\_map ) = \frac{{\sum }_{i} dist ( {p}_{i} , {q}_{i} ) \cdot weight ( {p}_{atti} , {q}_{atti} )}{n} \qquad Equation 1$$

where pᵢ, qᵢ represent a pair of associated points and pᵢ is a point from the high-definition map data HDₘₐₚ and qᵢ is a point from the local map data localₘₐₚ, pₐₜₜᵢ, qₐₜₜᵢ represent attributes of the perception data geometry features associated with the pair of associated points pᵢ, qᵢ, and n represents the total number of associated point pairs. In an embodiment where the perception data geometry features are lane lines, the attributes may include features such as, for example, line color and line type (e.g., solid, dashed, etc.). In another embodiment where the perception data features are road signs, the attributes may include color and type (e.g. speed limits, directions, etc.).

Once the cost function is calculated, the non-linear optimization submodule 66 of the non-linear optimization module 52 may then calculate the unique calibrated scaling ratio α corresponding to the particular road segment to minimize the cost function based on the one or more non-linear optimization algorithms. In response to determining the cost function has been minimized, the non-linear optimization submodule 66 of the non-linear optimization module 52 may then transmit the unique calibrated scaling ratio α corresponding to the particular road segment to the outlier removal module 54. However, in response to determining the cost function is not minimized, the non-linear optimization submodule 66 of the non-linear optimization module 52 may then transmit the unique calibrated scaling ratio α corresponding to the particular road segment to the scaling ratio submodule 60 of the non-linear optimization module 52. The non-linear optimization module 52 may then iteratively calculate the unique calibrated scaling ratio α until the cost function is minimized. The minimization may reduce the offset between the perception data geometry feature points from the local map data and the corresponding geometry feature points from the high definition (ground-truth) map data by applying a scaling ratio to the local map feature points. In one embodiment, the scaling ratio submodule 60 of the non-linear optimization module 52 may calculate the unique calibrated scaling ratio α corresponding to the particular road segment based on Equation 2, which is:

$$α = arg {min}_{α} ( cost\_function ( {HD}_{map} , {local}_{map} ) ) \qquad Equation 2$$

Referring to FIG. 2, once the cost function for each road segment that is part of the vehicle trajectory is minimized, the outlier removal module 54 of the one or more central computers 20 may receive the unique calibrated scaling ratio α corresponding to each road segment that is part of the vehicle trajectory. The outlier removal module 54 may evaluate the unique calibrated scaling ratio α corresponding to each road segment that is part of the vehicle trajectory to identify any outliers based on one or more outlier removal approaches. Some examples of outlier removal approaches include, but are not limited to, the random sample consensus (RANSAC) algorithm, the z-score algorithm, and the density-based spatial clustering of applications with noise (DBSCAN) algorithm. The outliers are removed from the vehicle trajectory, and the non-outliers may be used to update the local map data.

Once the unique calibrated scaling ratio α corresponding to each road segment that is part of the vehicle trajectory is determined, the one or more central computers 20 may then calibrate the plurality of perception data geometry features included by the local map data localₘₐₚ based on the unique calibrated scaling ratio α corresponding to each road segment that is part of the vehicle trajectory, and re-transmits the corrected local map data localₘₐₚ back to the particular vehicle 24.

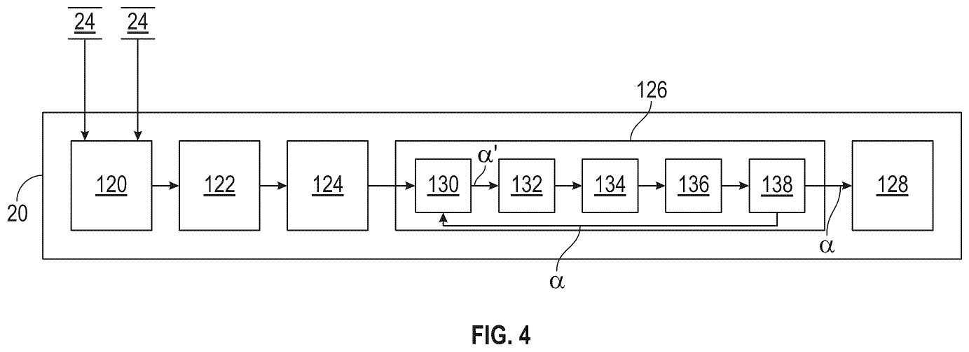

Referring back to FIG. 1, it is to be appreciated that in some instances, the high-definition map data HDₘₐₚ representing the predefined geographical area 32 may not be available. Accordingly, FIG. 4 is an illustration of an embodiment of the one or more central computers 20 for determining the unique calibrated scaling ratio α is based on a difference between corresponding perception data geometry features located within local map data created based on perception data corresponding to two or more vehicles 24 located within the predefined geographical area 32. It is to be appreciated that the two or more vehicles 24 are each located in different lanes along a roadway. As mentioned above, although FIG. 4 illustrates the software architecture for the one or more central computers 20, a similar architecture may be included by the one or more controllers 30 of a vehicle 24 as well.

Referring to both FIGS. 1 and 4, the central computer 20 includes a point cloud module 120, an alignment module 122, a precise positioning module 124, a non-linear optimization module 126, and an outlier removal module 128. The point cloud module 120 of the one or more central computers 20 receives a first set of perception data representative of the predefined geographical area 32 captured by the perception sensors 34 of a first vehicle 24 that is part of the plurality of vehicles 24 and a second set of perception data representative of the predefined geographical area 32 captured by the perception sensors 34 of a second vehicle 24 that is part of the plurality of vehicles 24, where the first and second vehicles 24 are located in two separate lanes of a roadway.

The point cloud module 120 of the one or more central computers 20 creates a first point cloud map v1_localₘₐₚ that is representative of the predefined geographical area 32 based on the first set of perception data and a second point cloud map v2_localₘₐₚ that is representative of the predefined geographical area 32 based on the second set of perception data. It is to be appreciated that the first point cloud map v1_localₘₐₚ and the second point cloud map v2_localₘₐₚ are both based on an arbitrary coordinate system. The first point cloud map v1_localₘₐₚ and the first point cloud map v1_localₘₐₚ include a plurality of perception data geometry features that define objects within the environment surrounding the first vehicle 24 and the second vehicle 24.

The alignment module 122 of the one or more central computers 20 receives the first point cloud map v1_localₘₐₚ and the second point cloud map v2_localₘₐₚ from the point cloud module 120 and aligns the first point cloud map v1_localₘₐₚ and the second point cloud map v2_localₘₐₚ with respect to the world coordinate system based on GNSS data collected by the GNSS 40 (FIG. 1) from a corresponding vehicle 24. Specifically, the GNSS data collected by the first vehicle 24 is used to align the first point cloud map v1_localₘₐₚ and the GNSS data collected by the second vehicle 24 is used to align the second point cloud map v2_localₘₐₚ. The alignment module 122 may align the first point cloud map v1_localₘₐₚ and the second point cloud map v2_localₘₐₚ with respect to the world coordinate system based on any type of alignment algorithm that performs translation, scaling, and rotation to align data such as, for example, pose graph optimization and bundle adjustment.

It is to be appreciated that alignments performed based on GNSS data tend to be less accurate for relatively shorter distances measured between two point cloud data points, such as distances under about ten meters, but tend to be more accurate for relatively longer distances measured between two point cloud data points, such as distances that are about one kilometer or more. Thus, longer distances (such as one kilometer or more) will be used when aligning the first point cloud map or the second point cloud map by the alignment module 122.

The precise positioning module 124 of the one or more central computers 20 may then receive the first point cloud map v1_localₘₐₚ and the second point cloud map v2_localₘₐₚ from the alignment module 122, and aligns the first point cloud map v1_localₘₐₚ with the perception data captured by the first vehicle 24 and the second point cloud map v1_localₘₐₚ with the perception data captured by the second vehicle 24 to create precise positioning for the point cloud data points that are part of the first point cloud map v1_localₘₐₚ and the second point cloud map v2_localₘₐₚ. In particular, it is to be appreciated that the precise positioning module 124 provides precise positioning between the point cloud data points corresponding to the first point cloud map v1_localₘₐₚ and the second point cloud data map v2_localₘₐₚ for relatively shorter distances (less than about ten meters). In other words, the precise positioning module 124 provides accurate positioning for relatively shorter distances after the alignment module 122 aligns the point cloud maps with relatively longer but more accurate distances.

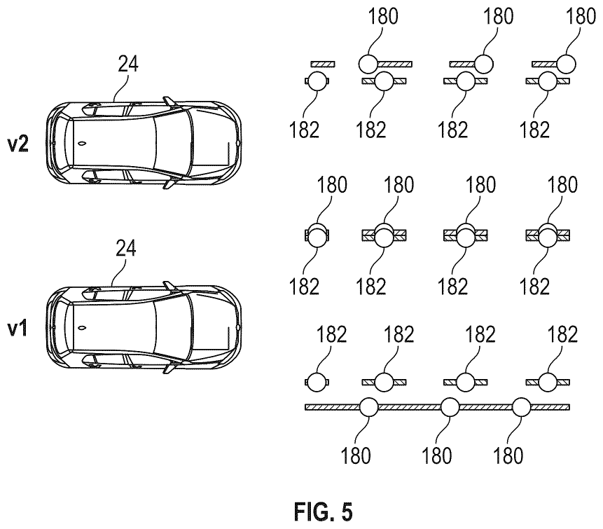

The non-linear optimization module 126 determines a unique calibrated scaling ratio α for each road segment that is part of the vehicle trajectory based on one or more non-linear optimization algorithms. The non-linear optimization module 126 of the one or more central computers 20 iteratively calculates the unique calibrated scaling ratio α to minimize a cost function between the point cloud data points 180 (shown in FIG. 5) that are based on the first point cloud map v1_localₘₐₚ with corresponding point cloud data points 182 that are based on the second point cloud map v2_localₘₐₚ.

The non-linear optimization module 126 of the one or more central computers 20 includes a segmentation submodule 130, a scaling ratio submodule 132, an association submodule 134, a cost function submodule 136, and a non-linear optimization submodule 138. The segmentation submodule 130 of the one or more central computers 20 divides a vehicle trajectory that is determined based on the perception data collected from the first vehicle 24 and the second vehicle 24 into a plurality of road segments.

The scaling ratio submodule 132 of the non-linear optimization module 126 first selects a temporary scaling ratio α′ that corresponds to a particular road segment that is part of the vehicle trajectory. The association submodule 134 of the non-linear optimization module 126 may then find an association between the point cloud data points 180 (shown in FIG. 5) that represent a particular perception data geometry feature within the first point cloud map v1_localₘₐₚ with corresponding point cloud data points 182 within the second point cloud map v2_localₘₐₚ that also represent the particular perception data geometry feature for the particular road segment.

It is to be appreciated that the point cloud data points 180 within the first point cloud map v1_localₘₐₚ and the corresponding point cloud data points 182 within the second point cloud map v2_localₘₐₚ are already accurate because of the alignments to the first point cloud map v1_localₘₐₚ and the second point cloud map v2_localₘₐₚ based on the GNSS data performed by the alignment module 122 and the precise positioning for the point cloud data points that are part of the first point cloud map v1_localₘₐₚ and the second point cloud map v2_localₘₐₚ performed by the precise positioning module 124. Accordingly, the unique calibrated scaling ratio α is determined so as to more closely align the point cloud data points that are part of the first point cloud map v1_localₘₐₚ with the point cloud data points that are part of the second point cloud map v2_localₘₐₚ.

Once the association between the point cloud data points 180 and the corresponding point cloud data points 182 for the particular road segment has been determined, the cost function submodule 136 of the non-linear optimization module 126 may then calculate a cost function based on a Euclidean distance between each point cloud data point 180 within the first point cloud map v1_localₘₐₚ and the corresponding point cloud data point 182 that is based on the second point cloud map v2_localₘₐₚ for the particular road segment. The unique calibrated scaling ratio α corresponding to the particular road segment is selected to minimize the cost function. Specifically, in one embodiment, the cost function is determined based on Equation 3, which is:

$$cost\_function ( v1\_local \_map , v2\_local \_map ) = \frac{{\sum }_{i} dist ( {p}_{i} , {q}_{i} ) \cdot weight ( {p}_{atti} , {q}_{atti} )}{n} \qquad Equation 3$$

where pᵢ, qᵢ represent a pair of associated points and pᵢ is a point from the second point cloud map v2_localₘₐₚ and qᵢ is a point from the first point cloud map v1_localₘₐₚ, and pₐₜₜᵢ, qₐₜₜᵢ represent attributes of the perception data geometry features associated with the pair of associated points pᵢ, qᵢ.

Once the cost function is calculated, the non-linear optimization submodule 138 of the non-linear optimization module 126 may then calculate the unique calibrated scaling ratio α corresponding to the particular road segment to minimize the cost function based on the one or more non-linear optimization algorithms. In response to determining the cost function has been minimized, the non-linear optimization submodule 138 of the non-linear optimization module 126 may then transmit the unique calibrated scaling ratio α corresponding to the particular road segment to the outlier removal module 128. However, in response to determining the cost function is not minimized, the scaling ratio submodule 132 of the non-linear optimization module 126 may then transmit the unique calibrated scaling ratio α corresponding to the particular road segment to the association submodule 132 of the non-linear optimization module 126. The non-linear optimization module 126 may then iteratively calculate the unique calibrated scaling ratio α until the cost function is minimized. In one embodiment, the non-linear optimization submodule 138 of the non-linear optimization module 126 may calculate the unique calibrated scaling ratio α corresponding to the particular road segment based on Equation 4, which is:

$$α = arg {min}_{α} ( cost\_function ( v1\_local \_map , v2\_local \_map ) ) \qquad Equation 4$$

Once the cost function for each road segment that is part of the vehicle trajectory is minimized, the outlier removal module 128 of the one or more central computers 20 may receive the unique calibrated scaling ratio α corresponding to each road segment that is part of the vehicle trajectory. The outlier removal module 128 may evaluate the unique calibrated scaling ratio α corresponding to each road segment that is part of the vehicle trajectory to identify any outliers based on one or more outlier removal approaches. The outliers are removed from the vehicle trajectory and the non-outliers may be used to update the local map data.

Once the unique calibrated scaling ratio α corresponding to each road segment that is part of the vehicle trajectory (that is a non-outlier) is determined, the one or more central computers 20 may then calibrate the plurality of perception data geometry features included by the first point cloud map v1_localₘₐₚ based on the unique calibrated scaling ratio α corresponding to each road segment that is part of the vehicle trajectory, and re-transmits the corrected first point cloud map v1_localₘₐₚ back to the first vehicle 24.

Referring generally to the figures, the disclosed perception data geometry calibration system provides various technical effects and benefits. Specifically, perception data geometry calibration system calibrates perception data geometry captured by one or more vehicles to improve the accuracy of map data. In particular, the disclosure provides an approach to calibrate the perception data geometry based on high-definition map data or, in the alternative, based on perception data captured between two different vehicles that are located within different lanes along a roadway. In embodiments where the perception data is captured between two vehicles, the perception data geometry calibration system performs alignments based on GNSS data for relatively longer distances measured between two point cloud data points and also performs precise positioning based on perception data for relatively shorter distances measured between two point cloud data points.

The central computers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A perception data geometry calibration system that calibrates perception data geometry captured by one or more vehicles located within a predefined geographical area, the perception data geometry calibration system comprising:
one or more central computers in wireless communication with the one or more vehicles and one or more communication networks for receiving high-definition map data, the one or more central computers executing instructions to:
receive local map data representing the predefined geographical area from a particular vehicle and corresponding high-definition map data over the communication network, wherein the local map data includes a plurality of perception data geometry features that define objects within an environment surrounding the particular vehicle;
divide a vehicle trajectory that is determined based on perception data collected from the particular vehicle into a plurality of road segments;
determine a unique calibrated scaling ratio for each road segment that is part of the vehicle trajectory based on one or more non-linear optimization algorithms, wherein the one or more central computers iteratively calculate the unique calibrated scaling ratio to minimize a cost function between road-segment points that represent a particular perception data geometry feature based on the local map data with corresponding road-segment points that are based on the high-definition map data; and
calibrate the plurality of perception data geometry features included by the local map data based on the unique calibrated scaling ratio corresponding to each road segment that is part of the vehicle trajectory to create a corrected local map.

2. The perception data geometry calibration system of claim 1, wherein the one or more central computers execute instructions to:
evaluate the unique calibrated scaling ratio corresponding to each road segment that is part of the vehicle trajectory to identify any outliers based on one or more outlier removal approaches.

3. The perception data geometry calibration system of claim 2, wherein the outlier removal approaches include one or more of the following: a random sample consensus (RANSAC) algorithm, a z-score, and a density-based spatial clustering of applications with noise (DBSCAN) algorithm.

4. The perception data geometry calibration system of claim 1, wherein the one or more central computers execute instructions to determine the unique calibrated scaling ratio by:
finding an association between the road-segment points that represent a particular perception data geometry feature within the local map data with the corresponding road-segment points within the high-definition map data that also represent the particular perception data geometry feature for each road segment that is part of the vehicle trajectory.

5. The perception data geometry calibration system of claim 4, wherein the one or more central computers execute instructions to determine the unique calibrated scaling ratio by:
calculating a cost function based on a Euclidean distance between each road-segment point within the local map data and the corresponding road-segment point that is based on the high-definition map data for each road segment that is part of the vehicle trajectory.

6. The perception data geometry calibration system of claim 5, wherein the cost function is determined based on:
$$cost\_function ( HD\_map , local\_map ) = \frac{{\sum }_{i} dist ( {p}_{i} , {q}_{i} ) \cdot weight ( {p}_{atti} , {q}_{atti} )}{n}$$
wherein pᵢ, qᵢ represent a pair of associated points and pᵢ is a point from the high-definition map data HDₘₐₚ and qᵢ is a point from the local map data localₘₐₚ, pₐₜₜᵢ, qₐₜₜᵢ represent attributes of the perception data geometry features associated with the pair of associated points pᵢ, qᵢ, n represents a total number of associated point pairs, and cost_function(HD_map, local_map) represents the cost function.

7. The perception data geometry calibration system of claim 6, wherein the perception data geometry features include one or more of the following: lane lines along a roadway, road signs, traffic lights, and location coordinates.

8. The perception data geometry calibration system of claim 7, wherein the perception data geometry features are lane lines and the attributes include one or more of the following: line color and line type.

9. The perception data geometry calibration system of claim 1, wherein a length of each road segment is equal to an average accurate perception range of the particular vehicle.

10. A perception data geometry calibration system that calibrates perception data geometry captured by one or more vehicles located within a predefined geographical area, the perception data geometry calibration system comprising:
a plurality of perception sensors that capture collect perception data regarding the predefined geographical area; and
one or more controllers in electronic communication with the plurality of perception sensors, wherein the one or more controllers are part of a particular vehicle that receive high-definition map data over a communication network, the one or more controllers executing instructions to:
determine local map data based on the perception data collected by the plurality of perception sensors, wherein the local map data includes a plurality of perception data geometry features that define objects within an environment surrounding the particular vehicle;
divide a vehicle trajectory that is determined based on perception data collected from the particular vehicle into a plurality of road segments;
determine a unique calibrated scaling ratio for each road segment that is part of the vehicle trajectory based on one or more non-linear optimization algorithms, wherein the one or more controllers iteratively calculate the unique calibrated scaling ratio to minimize a cost function between road-segment points that represent a particular perception data geometry feature based on the local map data with corresponding road-segment points that are based on the high-definition map data; and
calibrate the plurality of perception data geometry features included by the local map data based on the unique calibrated scaling ratio corresponding to each road segment that is part of the vehicle trajectory to create a corrected local map.

11. The perception data geometry calibration system of claim 10, wherein the one or more controllers execute instructions to:
evaluate the unique calibrated scaling ratio corresponding to each road segment that is part of the vehicle trajectory to identify any outliers based on one or more outlier removal approaches.

12. A perception data geometry calibration system that calibrates perception data geometry captured by two or more vehicles located within a predefined geographical area, the perception data geometry calibration system comprising:
one or more central computers in wireless communication with the two or more vehicles, the one or more central computers executing instructions to:
receive a first set of perception data representative of the predefined geographical area captured by a first vehicle and a second set of perception data representative of the predefined geographical area captured by a second vehicle;
create a first point cloud map representative of the predefined geographical area based on the first set of perception data and a second point cloud map representative of the predefined geographical area based on the second set of perception data, wherein the first point cloud map and the second point cloud map include a plurality of perception data geometry features that define objects within an environment surrounding the first vehicle and the second vehicle;
align the first point cloud map and the second point cloud map with respect to the world coordinate system based on a global navigation satellite system (GNSS) data collected a corresponding vehicle;
divide a vehicle trajectory that is determined based on perception data collected from the first vehicle and the second vehicle into a plurality of road segments;
determine a unique calibrated scaling ratio for each road segment that is part of the vehicle trajectory based on one or more non-linear optimization algorithms, wherein the one or more central computers iteratively calculate the unique calibrated scaling ratio to minimize a cost function between point cloud data points that represent a particular perception data geometry feature based on the first point cloud map with corresponding point cloud data points that are based on the second point cloud map; and
calibrate the plurality of perception data geometry features included by the first point cloud map based on the unique calibrated scaling ratio corresponding to each road segment that is part of the vehicle trajectory to create a corrected first point cloud map.

13. The perception data geometry calibration system of claim 12, wherein the one or more central computers execute instructions to:
evaluate the unique calibrated scaling ratio corresponding to each road segment that is part of the vehicle trajectory to identify any outliers based on one or more outlier removal approaches.

14. The perception data geometry calibration system of claim 13, wherein the outlier removal approaches include one or more of the following: a RANSAC algorithm, a z-score, and a DBSCAN algorithm.

15. The perception data geometry calibration system of claim 12, wherein the one or more central computers execute instructions to determine the unique calibrated scaling ratio by:
finding an association between the point cloud data points that represent a particular perception data geometry feature within the first point cloud map with the corresponding point cloud data points within the second point cloud map that also represent the particular perception data geometry feature for each road segment that is part of the vehicle trajectory.

16. The perception data geometry calibration system of claim 15, wherein the one or more central computers execute instructions to determine the unique calibrated scaling ratio by:
calculating a cost function based on a Euclidean distance between each point cloud data point within the first point cloud map and the corresponding point cloud data point that is based on the second point cloud map for each road segment that is part of the vehicle trajectory.

17. The perception data geometry calibration system of claim 16, wherein the cost function is determined based on:
$$cost\_function ( v1\_local \_map , v2\_local \_map ) = \frac{{\sum }_{i} dist ( {p}_{i} , {q}_{i} ) \cdot weight ( {p}_{atti} , {q}_{atti} )}{n}$$
wherein pᵢ, qᵢ represent a pair of associated points and pᵢ is a point from the second point cloud map v2_localₘₐₚ and qᵢ is a point from the first point cloud map v1_localₘₐₚ, and pₐₜₜᵢ, qₐₜₜᵢ represent attributes of the perception data geometry features associated with the pair of associated points pᵢ, qᵢ, n represents a total number of associated point pairs, and cost_function(v1_local_map, v2_local_map) represents the cost function.

18. The perception data geometry calibration system of claim 17, wherein the perception data geometry features include one or more of the following: lane lines along a roadway, road signs, traffic lights, and location coordinates.

19. The perception data geometry calibration system of claim 18, wherein the perception data geometry features are lane lines and the attributes include one or more of the following: line color and line type.

20. The perception data geometry calibration system of claim 12, wherein a length of each road segment is equal to an average accurate perception range of either the first vehicle or the second vehicle.
